(19) United States
(12) Patent Application Publication
(10) Pub. No.: US 2007/0227052 A1
(43) Pub. Date: Oct. 4, 2007

(54) Greettings card

(76) Inventor: Nicola Hartley, Lidsey (GB)

Correspondence Address: Paul Grandinetti;LEVY & GRANDINETTI, Suite 408, 1725 K Street, N.W., Washington, DC, 20006-1419, US

(21) Appl. No.: 11/717,173

(22) Filed: Mar. 13, 2007

(30) Foreign Application Priority Data
Mar. 14, 2006 (GB) 0605145.2

(51) Int. Cl. G09F 1/00

(52) U.S. Cl. 40/124.11

(57) ABSTRACT

A greetings card comprising a face panel and a back panel arrangeable at an angle to one another, in which the greetings card is constructed from a material adapted to be consumed by a non-human animal.

This invention relates to a greetings card, for use particularly, but not exclusively, as an edible greetings card for canines.

Greetings cards are commonly given to celebrate an annual occasion or individual event, for example a birthday, religious festival or wedding. In most cases these cards are given to humans, but occasionally a pet may be the recipient.

However, as pets cannot read, or appreciate the sentiment behind a greetings card, the gesture is usually somewhat lost on them.

The present invention is intended to overcome some of the above problems.

Therefore, according to the present invention a greetings card comprising a face panel and a back panel arrangeable at an angle to one another, in which the greetings card is constructed from a material adapted to be consumed by a non-human animal.

Thus, the present invention provides a greetings card which can be eaten by a recipient pet.

The invention could be adapted to be consumed by any non-human animal, however in a preferred embodiment the material can be canine consumable. Preferably the greetings card can be constructed from a material with sufficient structural integrity to stand up. A suitable canine edible material can be rawhide.

In a preferred embodiment indicia and/or decoration can be provided on the face panel. In one construction the face panel can be provided with apertures, and indicia and/or decoration panels can be fastened to the face panel using a strip or strips of canine consumable material threaded through the apertures. This strip or strips of canine consumable material can also be rawhide.

Preferably the greetings card can comprise a substantially rectangular piece of rawhide folded into a card shape. In one construction the piece of rawhide can comprise a first end and a second end, and can be foldable. In a first direction along a first line, and foldable in a second direction along a second line. The first line can be down the middle of the piece of rawhide, and the material between the first end and the first line can be the back panel. The material between the first line and the second line can be a spine panel, and the material between the second line and the second end can be the face panel.

It will be appreciated that rawhide is not a particularly flexible material, and therefore the first line and the second line can be scored so as to facilitate the folds. The angle which can be achieved by the folds depends on the thickness of the material, and the depth of the scores, however the idea is that the spine panel can be arranged at about 170 to 180 degrees to the back panel, and the front panel can be folded out from the spine panel to about 45 or more to allow the card to stand up. In a storage and transport configuration the front panel can overlie the back panel, and in a use configuration the front panel can be folded out to about 45 degrees or so.

The spine panel can be shorter in length than the front panel, and can comprise about 10 percent of the material on that side of the first line. In a preferred construction the piece of rawhide material can be substantially 10 inches long, and the spine panel can be substantially half an inch in length.

In one construction the back panel can be provided with one or more slots. Paper or card can be mounted in said slots in order to allow for a personal message to be written in the card.

The various rawhide components of the greetings card be coloured with a canine edible dye or paint in order to provide further decoration.

One embodiment of the invention will now be described by way of example and with reference to the accompanying drawings, in which:

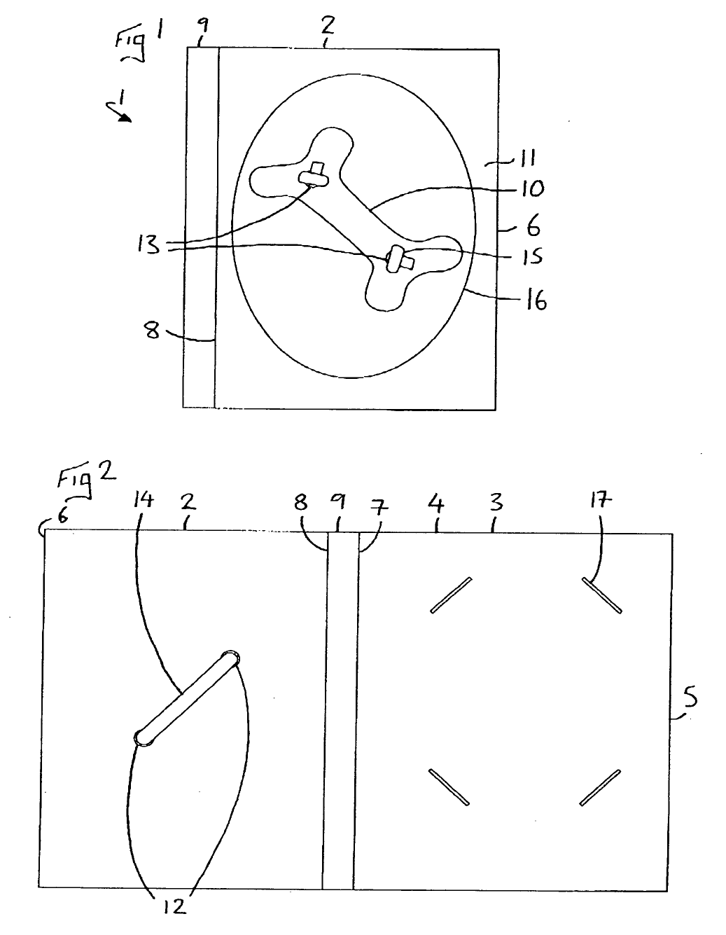

FIG. 1 is a front view of the front of a greetings card according to the present invention;

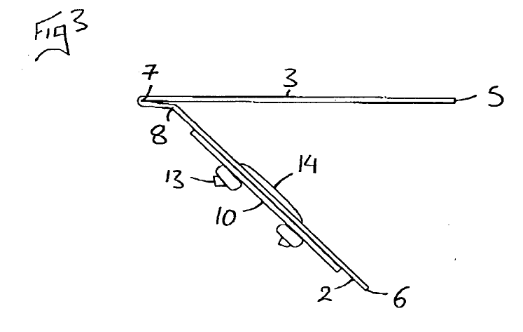

FIG. 2 is a front view of the insides of a greetings card as shown in FIG. 1; and,

FIG. 3 is a top view of the greetings card as shown in FIG. 1.

As shown in the Figures a greetings card 1 comprises a face panel 2 and a back panel 3 arrangeable at an angle to one another, as described below. The greetings card 1 is constructed from a material adapted to be consumed by a non-human animal, in the form of rawhide.

The greetings card 1 comprises a 10 inch long rectangular piece of rawhide 4, which is folded into a card shape. The piece of rawhide 4 comprises a first end 5 and a second end 6, and it is provided with first score line 7 down its middle, which is to say that it is equidistant from each end 5 and 6. A second score line 8 is provided between the first score line 7 and the second end 6. (The score lines 8 7 and 8 can be formed by scoring the inside of the material, the outside or both.)

The material between the first end 5 and the first score line 7 comprises the back panel 3, the material between the first score line 7 and the second score line 8 comprises a spine panel 9, and the material between the second score line 8 and the second end 6 comprises the face panel 2. The spine panel 2 is half and inch in length.

It will be appreciated that the score lines 7 and 8 allow the greetings card 1 to be configured in a number of ways. In FIG. 2 the greetings card is folded flat, as it would be during manufacture, but not during use. The score lines 7 and 8 have been formed, but the material 4 has not been folded yet.

FIG. 1 shows the greetings card 1 in a transport or storage configuration, in which the material 4 has been folded through about 170 or 180 degrees in a first direction about the first score line 7. A degree of force is required to fold the rawhide into this configuration, and it is not really possible to fold it out flat again.

FIG. 3 shows the greetings card 1 in a use configuration, in which the material 4 has been folded through about 45 degrees in a second direction about the second score line 8. Again, a degree of force is required to fold the rawhide into this configuration, although less than with score line 7. As such, a user can manually arrange the greetings card 1 as shown in FIGS. 1 and 3 with relative ease. In the configuration shown in FIG. 3, the card can be stood up.

An indicia panel in the form of bone-shaped panel 10 is attached to the front 11 of the face panel 2. Apertures 12 are provided in the face panel 2, and corresponding apertures 13 are provided in the bone-shaped panel 10. The apertures 12 and 13 are aligned, and a strip of rawhide 14 is threaded through them. The strip of rawhide 14 is tied into a knot 15 at each end to secure it in position.

A dye has been applied to the face panel 2 so decorative coloured shape 16 is formed. The dye is adapted to be consumed by canines.

The back panel 3 is provided with four slots 17. In use a piece of paper or card (not shown) can be fixed inside the card 1 by fitting its corners into the slots 17. If this paper is not canine edible is can be removed prior to allowing the recipient to chew the card 1.

It will be appreciated that the card 1 can be altered without departing from the scope of claim 1. In particular, in alternative embodiments (not shown) cards are constructed from alternative materials which are suitable for cats, and other pets to eat.

In addition, card 1 is only of the most basic construction and has only has one coloured section 16, and one indicial panel 10. However any number of coloured sections and indicia panels can be provided as desired, and positioned anywhere on the face panel 2 or the back panel 3.

Further, in another alternative embodiment (not shown) the indicia panel or panels are attached to the card with an edible glue.

Thus, a greetings card is provided for dogs, which represents a genuine treat they will enjoy.

1. A greetings card comprising a face panel and a back panel arrangeable at an angle to one another, in which the greetings card is constructed from a material adapted to be consumed by a non-human animal.

2. A greetings card as claimed in claim 1 in which the material is canine edible.

3. A greetings card as claimed in claim 2 in which the material is rawhide.

4. A greetings card as claimed in claim 2 in which indicia and/or decoration is provided on the face panel.

5. A greetings card as claimed in claim 4 in which the face panel is provided with apertures, and in which indicia and/or decoration panels are fastened to the face panel using a strip or strips of canine consumable material threaded through the apertures.

6. A greetings card as claimed in claim 5 in which the greetings card comprises a substantially rectangular piece of rawhide folded into a card shape.

7. A greetings card as claimed in claim 6 in which the piece of rawhide comprises a first end and a second end, in which the piece of rawhide material is foldable in a first direction along a first line, and foldable in a second direction along a second line which is spaced from the first line.

8. A greetings card as claimed in claim 6 in which the back panel is provided with one or more slots.

9. A greetings card as claimed in claim 5 in which the face panel and/or the back panel and/or the indicia and/or decoration panels are coloured with a canine edible dye or paint.

10. (canceled)
